(19) United States
(12) Patent Application Publication
(10) Pub. No.: US 2024/0106807 A1
(43) Pub. Date: Mar. 28, 2024

(54) Method for Transmitting Data By Way of at Least Two Moving Components, Computer Program Product, Transmitter and Receiver

(71) Applicant: Siemens Aktiengesellschaft, München (DE)

(72) Inventors: Markus Sauer, München (DE); Florian Zeiger, Höhenkirchen-Siegertsbrunn (DE)

(73) Assignee: Siemens Aktiengesellschaft, München (DE)

(21) Appl. No.: 18/549,031

(22) PCT Filed: Mar. 7, 2022
(86) PCT No.: PCT/EP2022/055692

§ 371 Date: Sep. 5, 2023

(30) Foreign Application Priority Data
Mar. 11, 2021 (EP) 21162111.5

(51) Int. Cl. H04L 9/40; H04W 12/106

(52) U.S. Cl. CPC H04L 63/0428; H04W 12/106

(57) ABSTRACT

Various embodiments include a method for transmitting data from a transmission source to a transmission target using at least two components of a network moving relative to the transmission source and/or transmission target. The method may include transmitting data using a distributed database having at least two parts transmitted by at least two of the components. The at least two parts are linked cryptographically to one another.

### CROSS-REFERENCE TO RELATED APPLICATIONS

This application is a U.S. National Stage Application of International Application No. PCT/EP2022/055692 filed Mar. 7, 2022, which designates the United States of America, and claims priority to EP Application No. 21162111.5 filed Mar. 11, 2021, the contents of which are hereby incorporated by reference in their entirety.

### TECHNICAL FIELD

The present disclosure relates to data transmission. Various embodiments include systems and/or methods for transmitting data from a transmission source to a transmission target by way of at least two components that are moving relative to the transmission source and/or transmission target.

### BACKGROUND

In the global industry, a constantly available networking capability and communication connection is crucial for satisfying customer needs. In many parts of the world, the requirements for a networking capability and communication connection are not met. It is therefore necessary to resort to satellite communication in such cases. New satellite communication technologies, on account of their architecture, will transmit data in a manner different from what is carried out by modern, usually geostationary systems. Especially in the case of future LEO satellite systems, developments of the approach of “storing and forwarding” data are therefore a highly important technology. One challenge here is ensuring the integrity of data that are transmitted by way of multiple satellites.

### SUMMARY

The teachings of the present disclosure include an improved systems and/or methods for transmitting data from a transmission source to a transmission target by way of at least two components that are moving relative to the transmission source and/or transmission target. Integrity of the data transmitted by way of the method should be able to be ensured. For example, some embodiments include a method for transmitting (TDPDC) data from a transmission source (DP) to a transmission target (DC) by way of at least two components (DSC1, DSC2, DSC3, DSCn) of a network that are moving relative to the transmission source (DP) and/or transmission target (DC), in which method the transmission takes place by way of a distributed database (DDB) having at least two parts (S1, S2, S3, Sn) that are transmitted by way of at least two of the components (DSC1, DSC2, DSC3, DSCn), and wherein the parts (S1, S2, S3, Sn) of the distributed database (DDB) are linked cryptographically to one another.

In some embodiments, the transmission (TDPDC) comprises at least sending and/or receiving.

In some embodiments, the at least two components (DSC1, DSC2, DSC3, DSCn) that are moving relative to one another comprise at least one vehicle, in particular marine vehicle and/or land vehicle and/or aircraft, and/or a satellite as at least one component.

In some embodiments, in each case one of the parts (S1, S2, S3, Sn) is transmitted by a respective one of the components (DSC1, DSC2, DSC3, DSCn).

In some embodiments, in each case one of the parts (S1, S2, S3, Sn) is transmitted multiple times by way of a respective one, and not necessarily identical one, of the components (DSC1, DSC2, DSC3, DSCn).

In some embodiments, the moving components (DSC1, DSC2, DSC3, DSCn) are not used to transmit in each case all parts (S1, S2, S3, Sn) of the distributed database (DDB), but rather at most an actual partial set of the parts (S1, S2, S3, Sn) of the distributed database (DDB).

In some embodiments, the parts (S1, S2, S3, Sn) are linked cryptographically to one another such that the parts (S1, S2, S3, Sn) are arranged in at least one sequence in relation to one another, wherein each part (S2, S3, Sn) of the sequence that follows a preceding part (S1, S2, S3) is provided with at least one hash value (S1H, S2H, Sn-1H) of this preceding part (S1, S2, S3).

In some embodiments, in each case a signature (DSC1S, DSC2S, DSCnS) of the parts (S1, S2, S3, Sn) is requested or received in each case by a component (DSC1, DSC2, DSC3, DSCn) by way of which these parts are transmitted.

In some embodiments, the method is computer-implemented.

As another example, some embodiments include a computer program product, designed, and configured to transmit (TDPDC) data from a transmission source to a transmission target by way of at least two components (DSC1, DSC2, DSC4, DSC4, DSCn) that are moving relative to the transmission source and/or transmission target, in accordance with one or more of the methods as described herein, which computer program product is designed to distribute the data into a distributed database (DDB) having at least two parts (S1, S2, S3, Sn) or to compose said data from a distributed database (DDB) having at least two parts, wherein the parts of the distributed database are linked cryptographically to one another, and to transmit (TDPDC) the parts (S1, S2, S3, Sn) by way of at least two of the components (DSC1, DSC2, DSC4, DSC4, DSCn), wherein the computer program product is configured to request or receive a respective signature (DSC1S, DSC2S, DSCnS) of the parts (S1, S2, S3, Sn) by a component (DSC1, DSC2, DSC4, DSC4, DSCn) by way of which these parts are transmitted.

As another example, some embodiments include a transmitter and/or receiver, designed to implement one or more of the methods as described herein.

### BRIEF DESCRIPTION OF THE DRAWINGS

The teachings of the present disclosure are explained in more detail below with reference to exemplary embodiments illustrated in the drawing. In the figures:

FIG. 1 shows a schematic basic sketch of a database for implementing a method incorporating teachings of the present disclosure for transmitting data by way of at least two moving components; and

FIG. 2 shows a schematic basic sketch of a transmitter and a receiver in an implementation incorporating teachings of the present disclosure.

### DETAILED DESCRIPTION

Some embodiments of the teachings herein include a method for transmitting data from a transmission source to a transmission target by way of at least two components of a network that are moving relative to the transmission source and/or transmission target, the transmission takes place by way of a distributed database having at least two parts, wherein the parts are transmitted by way of at least two of the components, and wherein the parts of the distributed database are linked cryptographically to one another.

The methods described herein thus address the difficulties in known methods of ensuring the integrity of data transmitted by way of moving components of a network. To this end, use is made of a distributed database having cryptographically linked parts, that is to say a data structure that is known from blockchain technology. Such a data structure, which is already used to ensure the integrity of transactions in blockchains, may also be used to ensure the integrity of transmissions in delay-tolerant networks. It is therefore possible to ensure the integrity of the transmitted data in particular in such networks having moving components such as satellites. Such cryptographic links, in particular checksums, hash values and/or digital signatures, may therefore be used to ensure integrity not just in a chronological sequence of blocks. The cryptographic link also makes it possible to ensure integrity of data in a spatially distributed database having multiple parts.

The cryptographic link may be used to reconstruct the parts of the distributed database. The cryptographic link may be used to record the relationship between the parts of the distributed database, such that, when the data are received, the cryptographic link may expediently be used to recombine the parts of the distributed database correctly to form the original data.

In some embodiments, the transmission comprises at least sending and/or receiving, that is to say the method may be used both for sending and for receiving and for alternate or simultaneous sending and receiving. In some embodiments, the data that are transmitted form a dataset or a document.

In some embodiments, the at least two components that are moving relative to one another comprise at least one vehicle, in particular marine vehicle and/or land vehicle and/or aircraft, and/or a satellite as at least one component. In some embodiments, the components are satellites that are moving for example at 600-800 kilometers above the Earth's surface, for example with an orbital period synchronized with the sun and for example an orbital period of between 60 and 120, preferably around 90 minutes.

In some embodiments, in each case one of the parts is transmitted by way of a respective one of the components. In each case individual parts of the distributed database are therefore transmitted by way of one component and do not have to be distributed specifically among multiple components. In some embodiments, however, parts may be transmitted redundantly, that is to say in each case multiple times by way of a respective component. The transmission is thereby additionally protected against transmission errors and manipulation attempts.

In each case one of the parts is expediently transmitted multiple times by way of a respective one, and not necessarily identical one, of the components. Each of the parts is expediently linked cryptographically to further parts of the distributed database.

In some embodiments, the moving components of the network are not each used, that is to say a respective component is not used, to transmit all parts of the distributed database. In some embodiments, at most one actual partial set or actual subset of the parts of the distributed database is transmitted by a respective component. The actual partial set or actual subset in this case does not contain all parts, but rather fewer parts, for instance at least one part contains fewer or at most half of the parts or in particular fewer than half of the parts.

The distributed database may thereby be transmitted by way of parts in the form of what are known as shards, wherein the method is able to be scaled particularly well as a result of the actual partial set, that is to say as a result of the transmission of not all parts, of the distributed database. As a result of the methods described herein, it is therefore not necessary to multiply the transmission capacities. The methods make it possible to use transmission windows of the moving components of the network that would not be sufficient on their own for transmission of the entire distributed database. On the contrary, the methods described herein transmit the complete database by way of the multiple moving components jointly, that is to say considered together.

In some embodiments, at most one actual partial set of the parts of the distributed database is transmitted by each of the moving components. In some embodiments, the parts are linked cryptographically to one another such that the parts are arranged in at least one sequence in relation to one another, wherein each part of the sequence that follows a preceding part is provided with at least one hash value of this preceding part. In principle, multiple or all parts may also be transmitted redundantly, wherein each part of the sequence that follows a part present in redundant form, that is to say a part present multiple times, is provided with at least the hash value of the respective identical parts that are present multiple times.

In some embodiments, a respective signature of the parts is requested or received in each case by a component by way of which these parts are transmitted. In this development, the signature means a signature of the respective parts performed by the component. The component thereby verifies the respective part, such that the method is additionally protected against undiscovered manipulation or data transmission errors, since manipulations or data transmission errors of individual parts are able to be recognized easily as a result of an invalid signature. A public key corresponding to the signature is expediently additionally transmitted here, such that the signature is able to be checked easily.

In some embodiments, the method is computer-implemented.

Some embodiments include a computer program product designed and configured to transmit data from a transmission source to a transmission target by way of at least two components that are moving relative to the transmission source and/or transmission target in accordance with one or more of the methods described above. The computer program product is designed to distribute the data into a distributed database having at least two parts or to compose said data from a distributed database having at least two parts, wherein the parts of the distributed database are linked cryptographically to one another, and to transmit the parts by way of at least two of the components, wherein the computer program product is configured to request or receive in each case a signature of the parts performed by a component by way of which these parts are transmitted.

The transmitter and/or receiver incorporating teachings of the present disclosure is designed to implement one or more of the methods described herein and/or has a computer program product as described herein.

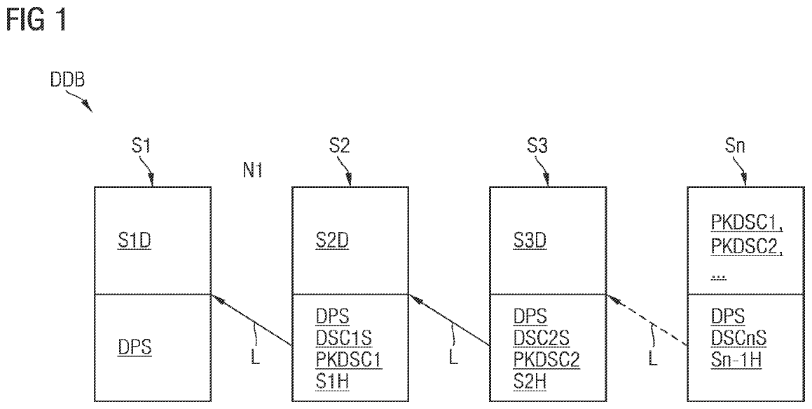

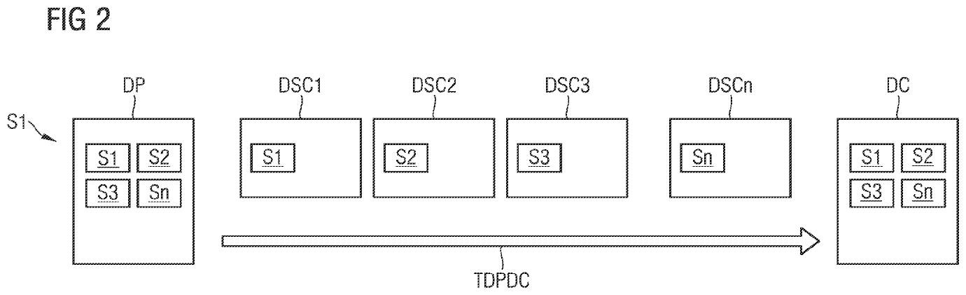

In the example method illustrated with reference to FIGS. 1 and 2, data are sent from a transmitter in the form of an edge device DP to a receiver in the form of a server DC. In the illustrated exemplary embodiment, the data form a document, but may also, in other exemplary embodiments form other data, for instance a database.

The data are transmitted by way of a satellite network of for example 50 satellites DSC1, DSC2, DSC3, DSCn as components of the network. The satellites DSC1, DSC2, DSC3, DSCn orbit in a low earth orbit at an altitude of 700 to 800 kilometers above the Earth with an orbital period of 90 minutes.

The edge device DP sends the document to the server DC as follows:

The edge device DP, in a preparatory step, divides the data of the document into a distributed database DDB having multiple parts S1, S2, S3, Sn, which are also referred to as shards. The parts S1, S2, S3, Sn are linked cryptographically to one another by way of cryptographic links L like blocks of a blockchain. The cryptographic links L of the parts S1, S2, S3, Sn of the distributed database DDB ensure the integrity of the document.

The data are divided into the individual parts of the distributed database by way of a software module of the field device DP, which software module is not illustrated specifically in the drawing. The software module plans the size of the parts S1, S2, S3 on the basis of the usable communication windows of the satellites DSC1, DSC2, DSC3, DSCn. Such communication windows are determined for example by way of a transmission window component based on status data of the satellites DSC1, DSC2, DSC3, DSCn.

When a suitable communication window of a first satellite DSC1 passing the edge device DP is open, then the first satellite DSC1 signals its availability for the edge device DP by way of an availability signal and sends an offer of transmission resources, for example a data transmission rate and a storage availability of the first satellite DSC1, to the edge device DP.

When the offer of the transmission resources matches the requirements of the edge device DP, then the edge device DP encrypts the data S1D of a first part S1 of the distributed database DDB and then adds, to the data S1D of the first part S1, billing data of the first satellite DSC1 and receiver data that identify the server DC as intended receiver. The edge device then signs the first part S1, supplemented in this way, with a digital signature DPS of the edge device DP. In some embodiments, depending on the sensitivity of the data to be transmitted, the encryption of the data S1D of the first part S1 by the edge device DP may also be dispensed with.

The edge device DP then sends the first part S1 of the distributed database to the first satellite DSC1.

When the transmission of the first part S1 to the first satellite DSC1 is complete, the first satellite DSC1 calculates a hash value of the first part S1 and signs the first part S1 with a local private key of the first satellite DSC1. The first satellite DSC1 then sends the hash value S1H of the first part S1 together with its public key PKDSC1 to the edge device DP. The edge device DP stores the signature DSC1S and the public key of the first satellite DSC1 in a key memory of the edge device DP and retains the hash value S1H of the first part S1 in a main memory of the edge device DP.

The edge device DP then encrypts the data S2D of a second part S2 of the distributed database DDB and appends thereto the hash value S1H of the first part S1 and the signature DSC1S of the first satellite DSC1. The edge device DP then signs the second part S2, supplemented in this way, of the distributed database.

If the communication window of the first satellite DSC1 is still open, the edge device sends the second part S2 to the first satellite DSC1. If the communication window of the first satellite DSC1 is closed, the edge device DP waits for a following communication window of a second satellite DSC2. The latter situation is shown in FIG. 1.

All parts of the distributed database DDB are thereby transmitted to satellites DSC1, DSC2, DSC3, DSCn with available transmission resources. In other words, the satellite DSC3 receives the part S3 to which the signature DPS of the edge device DP, the signature DCS2S of the second satellite DSC2 and the public key PKDCS2 of the second satellite DCS2, along with a hash value S2H of the second part S2 of the distributed database, are appended. When all parts of the distributed database that contain data of the document to be transmitted have been transmitted, a last part Sn of the distributed database is generated by generating a hash value Sn-1H of the last transmitted part S3 that contains data S3D of the document to be transmitted and adding the buffer-stored signatures DSCnS of the satellites DSC1, DSC2, DSC3, DSCn by way of which the parts S1, S2, S3, Sn have been signed and the public keys PKDSC1, PKDSC2 of these satellites DSC1, DSC2, DSC3, DSCn and the signature DPS of the edge device DP.

In the methods described herein, parts S1, S2, S3, Sn of the distributed database DDB may be transmitted redundantly, wherein a part transmitted following the redundantly transmitted part contains all signatures of the satellites DSC1, DSC2, DSC3, DSCn involved in the transmission of the redundantly transmitted part.

The distributed database DDB transmitted by way of the example method has the structure illustrated in FIG. 1 and is transmitted from the edge device DP to the server DC by way of the transmission step TDPDC illustrated in FIG. 2.

The cryptographic link L between the parts S1, S2, S3, Sn of the distributed database DDB is used in the method to reconstruct the original document: When one of the satellites DSC2 passes the server DC and has not yet transmitted to the server DC that part S2 of the distributed database DDB that is transmitted to the satellite DSC2, then the satellite DSC2 sends the part S2 to the server DC.

The server DC collects all parts S1, S2, S3, Sn of the distributed database DDB. As soon as the server DC has received all parts S1, S2, S3, Sn of the distributed database DDB, the server begins to reconstruct the transmitted data by way of an order of the parts of the distributed database based on the link between the parts S1, S2, S3, Sn by way of the hash values S1H, S2H, Sn-1H. To this end, the server DC has a software-based reproduction module. The reproduction module verifies the integrity of the parts S1, S2, S3, Sn based on the public keys PKDCS1, PKDSC2, . . . of the satellites DSC1, DSC2, DSC3, DSCn and the signatures DSC1S, DSC2S, DSCnS of the parts S1, S2, S3, Sn.

Following successful verification of the received parts S1, S2, S3, Sn, the reproduction module of the server DC decrypts the parts S1, S2, S3, Sn of the distributed database DDB, reconstructs the distributed database DDB and recombines the parts S1, S2, S3, Sn of the distributed database DDB to form the document to be transmitted. The document has therefore been transmitted from the edge device DP to the server DC by way of the methods described herein.

In some embodiments, the entire distributed database DDB is not transmitted by way of each of the satellites DSC1, DSC2, DSC3, DSCn, but rather only at most an actual partial set of the parts S1, S2, S3, Sn of the distributed database DDB is transmitted by way of each of the satellites DSC1, DSC2, DSC3, DSCn.

What is claimed is:

1. A method for transmitting data from a transmission source to a transmission target at least two components of a network moving relative to the transmission source and/or transmission target, the method comprising:
transmitting data using a distributed database having at least two parts transmitted by at least two of the components;
wherein the at least two parts are linked cryptographically to one another.

2. The method as claimed in claim 1, wherein transmission comprises sending and/or receiving.

3. The method as claimed in claim 1, wherein the at least two components comprise at least one vehicle.

4. The method as claimed in claim 1, wherein one of the at least two parts is transmitted by a respective one of the components.

5. The method as claimed in claim 1, in each case one of the two parts is transmitted multiple times by way of a respective one of the at least two components.

6. The method as claimed in claim 1, wherein the moving components are not used to transmit in each case all parts of the distributed database, but rather at most an actual partial set of the parts of the distributed database.

7. The method as claimed in claim 1, wherein:
the parts are linked cryptographically to one another such that the parts are arranged in at least one sequence in relation to one another;
each part of the sequence that follows a preceding part is provided with at least one hash value of this preceding part.

8. The method as claimed in claim 1, wherein in each case a signature of the parts is requested or received in each case by a component by way of which these parts are transmitted.

9. (canceled)

10. A non-transitory computer memory storing a set of instructions, wherein the set of instructions cause a processor to:
transmit data from a transmission source to a transmission target by way of at least two components moving relative to the transmission source and/or transmission target; and
distribute the data into a distributed database having at least two parts or to compose said data from a distributed database having at least two parts, wherein the parts of the distributed database are linked cryptographically to one another;
transmit the parts by way of at least two of the components; and
request or receive a respective signature of the parts by a component by way of which these parts are transmitted.

11. (canceled)
